(19) United States
(12) Patent Application Publication
(10) Pub. No.: US 2007/0102596 A1
(43) Pub. Date: May 10, 2007

(54) Tension adjusting device of support assembly for liquid crystal display

(76) Inventor: Roger Sung, Lujhu Township (TW)

Correspondence Address: PRO-TECHTOR INTERNATIONAL SERVICES, 20775 NORADA CT., SARATOGA, CA, 95070, US

(21) Appl. No.: 11/270,026

(22) Filed: Nov. 8, 2005

(51) Int. Cl. F16M 11/00

(52) U.S. Cl. 248/122.1

(57) ABSTRACT

A support assembly for a liquid crystal display includes a main frame, a connecting seat mounted to an end of the main frame, a coupler mounted to the connecting seat, a liquid crystal display mounting member mounted to the connecting seat, and a tension adjusting device. The tension adjusting device includes an adjusting block and at least one elastic element having a first end attached to the adjusting block to move therewith and a second end fixed to the main frame. The position of the adjusting block can be adjusted for altering tension of the at least one elastic element for supporting a liquid crystal display mounted to the liquid crystal display mounting member.

### BACKGROUND OF THE INVENTION

1. Field of the Invention

The present invention relates to a support assembly. More particularly, the present invention relates to a support assembly for a liquid crystal display.

2. Description of the Related Art

Due to the coming of the digital era, popularization of the Internet, and the change in the digital transmission signals, liquid crystal displays are widely used as the monitors for computers and televisions in the digital era, for the liquid crystal displays are lightweight, power-saving, and free of radiation. Generally, a liquid crystal display is placed on a table or the like and supported by a support assembly allowing or not allowing adjustment of the position of the liquid crystal display. Support assemblies allowing adjustment of the position of the liquid crystal display are more commonly used.

Since there are various types of liquid crystal displays with different weights, the support assembly might be subject to different loads resulting from the weight and/or position of the liquid crystal display. More specifically, the support assembly is subject to a greater load when the liquid crystal display is heavier or in an inclined position. The larger the inclination angle of the liquid crystal display, the greater the load imparted to the support assembly. Conventional support assemblies could not be adjusted to provide different tension for supporting the liquid crystal display with different weights and/or at different inclined states.

### SUMMARY OF THE INVENTION

A support assembly for a liquid crystal display in accordance with the present invention comprises a main frame including a first end and a second end adapted to be pivotally mounted an object, a connecting seat mounted to the first end of the main frame, a coupler mounted to the connecting seat, a liquid crystal display mounting member mounted to the connecting seat, and a tension adjusting device. The tension adjusting device comprises an adjusting block, at least one elastic element including a first end attached to the adjusting block to move therewith and a second end fixed to the main frame, and means for moving the adjusting block for altering tension of the at least one elastic element for supporting a liquid crystal display adapted to be mounted to the liquid crystal display mounting member.

Preferably, the connecting seat is pivotally connected to the first end of the main frame.

Preferably, the coupler is pivotally connected to the connecting seat.

Preferably, the liquid crystal display mounting member is pivotally connected to the connecting seat.

In an embodiment of the invention, the main frame comprises a first bracket having a hole and a second bracket having a hole aligned with the hole of the first bracket. The adjusting block comprises a screw hole. A screw rod extends through the holes of the first bracket and the second bracket and the screw hole of the adjusting block. The screw rod is turnable to cause the adjusting block to move relative to the main frame.

Preferably, at least one guide rod is fixed to the main frame and the at least one elastic element is mounted around the at least one guide rod.

Preferably, the at least one guide rod is fixed between the first bracket and the second bracket and extends through the adjusting block.

Preferably, the support assembly further comprises means for indicating the tension of the at least one elastic element.

Preferably, the adjusting block comprises an indicator visible from outside of the main frame.

Preferably, the main frame comprises a window through which the indicator of the adjusting block is visible.

Preferably, the adjusting block comprises a bar having at least one groove into which the first end of the at least one elastic element is mounted.

Other objectives, advantages, and novel features of the invention will become more apparent from the following detailed description when taken in conjunction with the accompanying drawings.

### BRIEF DESCRIPTION OF THE DRAWINGS

FIG. 1 is a front perspective view of a support assembly for a liquid crystal display in accordance with the present invention.

FIG. 2 is a rear perspective view of the support assembly for a liquid crystal display in accordance with the present invention.

FIG. 3 is an exploded perspective view of a tension adjusting device of the support assembly in accordance with the present invention.

FIG. 4 is an exploded perspective view of a main portion of the tension adjusting device of the support assembly in accordance with the present invention.

FIG. 5 is a sectional view of the support assembly in accordance with the present invention.

FIG. 6 is an enlarged view of a portion of the support assembly in FIG. 5.

FIG. 7 is a view similar to FIG. 6, illustrating adjustment of a position of an adjusting block of the tension adjusting device.

FIG. 8 is a view similar to FIG. 5, wherein the support assembly is an inclined state.

FIG. 9 is a view similar to FIG. 8, wherein the support assembly is in a further inclined state.

### DETAILED DESCRIPTION OF THE PREFERRED EMBODIMENT

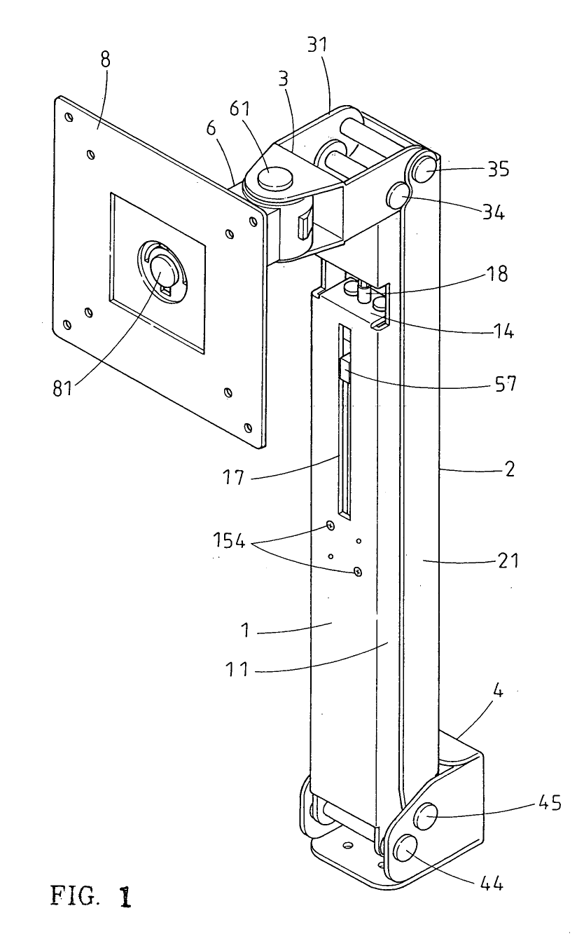

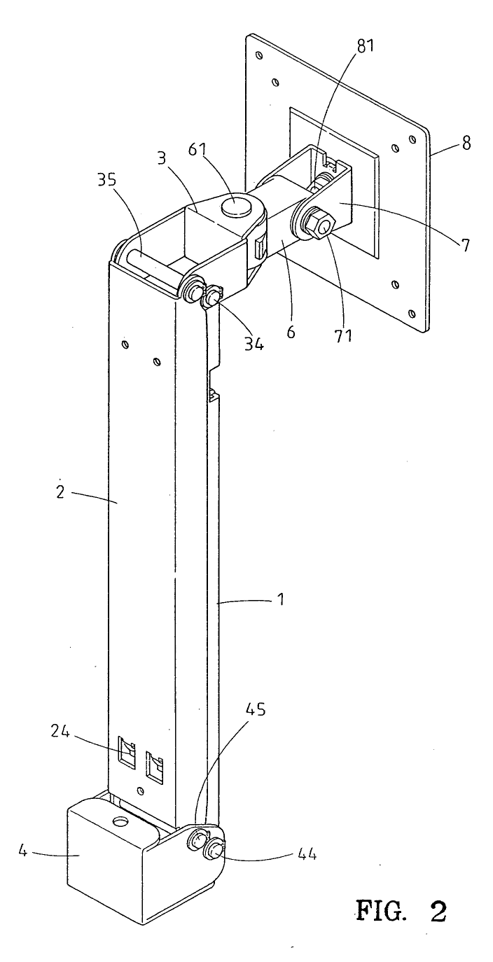

Referring to FIGS. 1 through 3, a support assembly for a liquid crystal display in accordance with the present invention comprises a main frame, a connecting seat 3, a coupler 6, and a liquid crystal display mounting member 8. The connecting seat 3 is pivotally connected by pins 34 and 35 to an end (the upper one in FIGS. 1 through 3) of the main frame. The coupler 6 is pivotally connected by a vertical pin 61 to the connecting seat 3. The liquid crystal display mounting member 8 is pivotally connected by a transverse pin 71 to the coupler 6. A liquid crystal display (not shown) is mounted to the liquid crystal display mounting member 8. The other end of the main frame is fixed to an object such as a fixing seat 4, which, in turn, is mounted on a table or the like. Thus, the overall support assembly is mounted on the table or the like together with the liquid crystal display.

In the illustrated embodiment, the main frame comprises a first frame 1 and a second frame 2. Each of the first frame 1 and the second frame 2 is substantially U-shaped and comprises two sidewalls 11, 21. The pin 35 is extended through aligned holes 22 in an upper end of the second frame 2 and holes 33 in an end of the connecting seat 3, and the pin 34 is extended through aligned holes 12 in an upper end of the first frame 1 and holes 32 in the end of the connecting seat 3. A retainer clip 36 is provided to retain each of the pins 34 and 35 in place. A lower, second end of the first frame 1 includes aligned holes 13. Similarly, a lower, second end of the second frame 2 includes aligned holes 23. A pin 44 is extended through the holes 13 of the first frame 1 and aligned holes 42 of the fixing seat 4. Another pin 45 is extended through the holes 23 of the second frame 2 and aligned holes 43 of the fixing seat 4. A retainer clip 46 is provided to retain each of the pins 34 and 35 in place. Thus, the four pins 34, 35, 44 and 45 provide a parallelogram linkage.

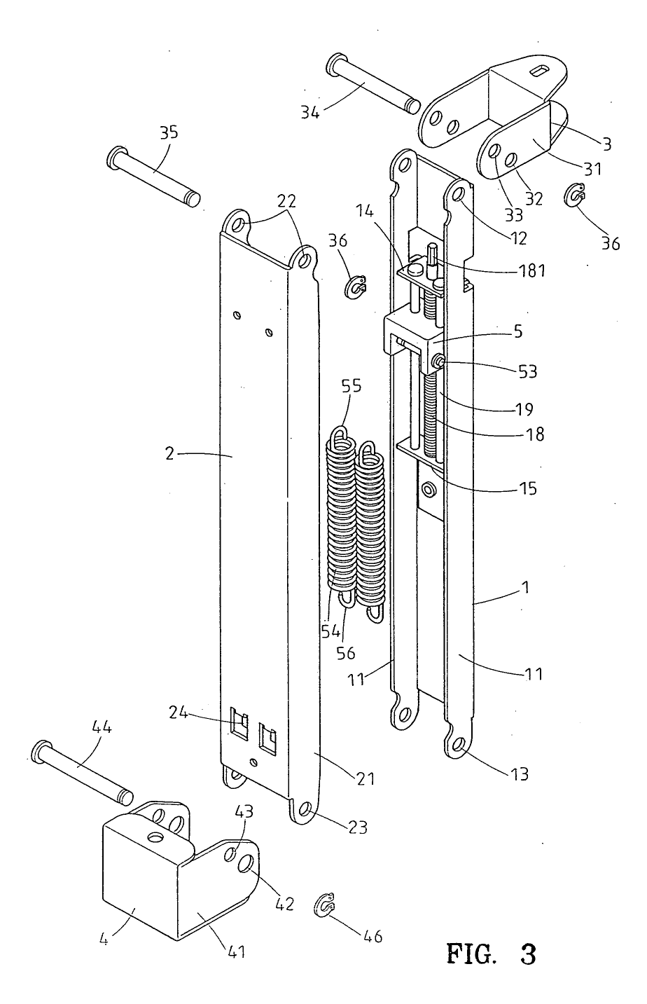

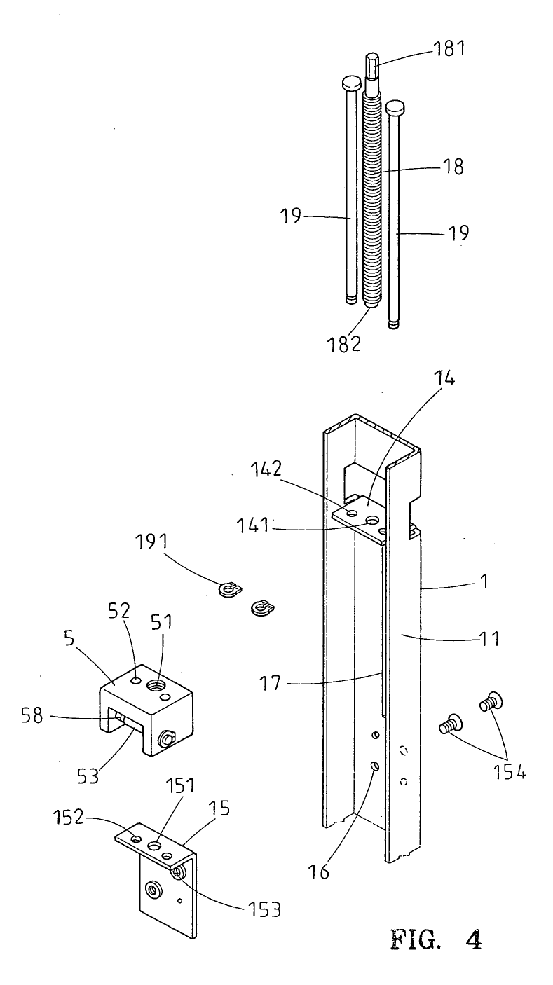

Referring to FIGS. 3 through 6, the support assembly further comprises a tension adjusting device for adjusting the tension for supporting the liquid crystal display. In the illustrated embodiment, the first frame 1 comprises a first bracket 14 and a second bracket 15 formed thereon or mounted thereto. The first bracket 14 may be formed by punching the first frame 1 inward, and the second bracket 15 may be fixed by extending screws 154 through screw holes 153 of the second bracket 15 and holes 16 in the first frame 1. Preferably, the first bracket 14 and the second bracket 15 are spaced along a longitudinal direction of the main frame.

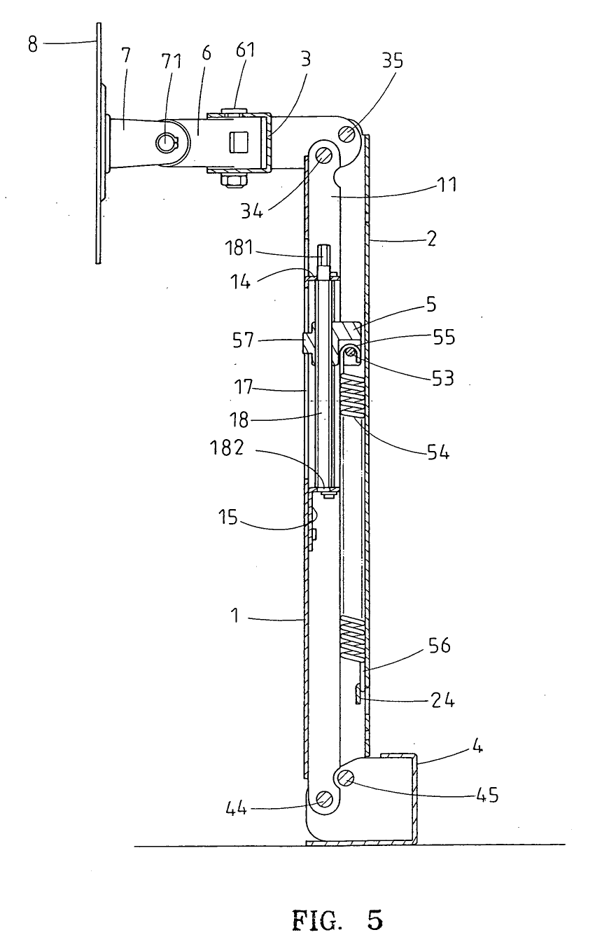

The first bracket 14 comprises a hole 141 and the second bracket 15 comprises a hole 151 aligned with the hole 141 of the first bracket 14. The tension adjusting device comprises a screw rod 18 extending through the holes 141 and 151 of the first and second brackets 14 and 15. Mounted on the screw rod 18 is an adjusting block 5 including a screw hole 51 through which the screw rod 18 is extended. As illustrated in FIG. 5, a lower end 182 of the screw rod 18 is fixed below the second bracket 15, allowing free rotation of the screw rod 18. An upper end 181 of the screw rod 18 extends beyond the first plate 14 to allow manual operation or driving by a tool such as a wrench or the like. Thus, by turning the screw rod 18, the adjusting block 5 is movable along the screw rod 18 relative to the main frame.

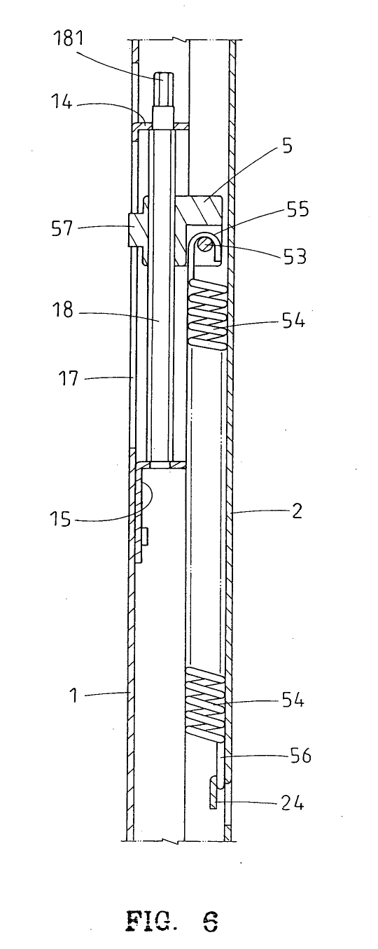

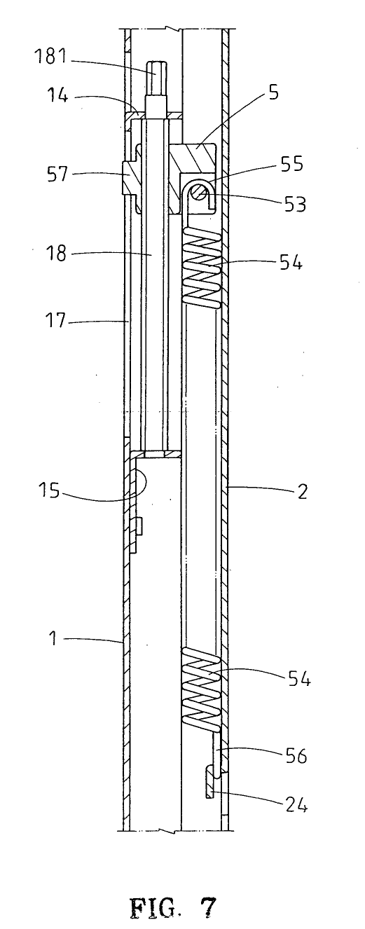

At least one elastic element 54 (two in this embodiment) includes a first end 55 attached to the adjusting block to move therewith and a second end 56 attached to the main frame. In the illustrated embodiment, the second end 56 of each elastic element 54 is attached to a bracket 24 on the second frame 2. The adjusting block 5 includes a bar 53 having two grooves 58 into which the first ends 55 of the elastic elements 54 are mounted. By such an arrangement, when the screw rod 18 is turned and thus moves the adjusting block 5 relative to the main frame, the first end 55 of each elastic element 54 moves together with the adjusting block 5, thereby adjusting the tension of the elastic elements 54 for supporting the liquid crystal display (see FIGS. 6 and 7). Preferably, the elastic elements 54 are tension springs.

Each of the first plate 14 and the second plate 15 may further include at least one guiding hole 142, 152 (two in this embodiment) and the adjusting block 5 may further include at least one guiding hole 52 (two in this embodiment) aligned with the guiding holes 142 and 152. A corresponding number of guide rod 19 (two in this embodiment) are extended through the guiding holes 142, 152, and 52 of the first and second brackets 14 and 15 and the adjusting block 5, with each elastic element 54 extending around an associated guide rod 19. The guide rods 19 avoid undesired twist, bending, or deformation of the elastic elements 54.

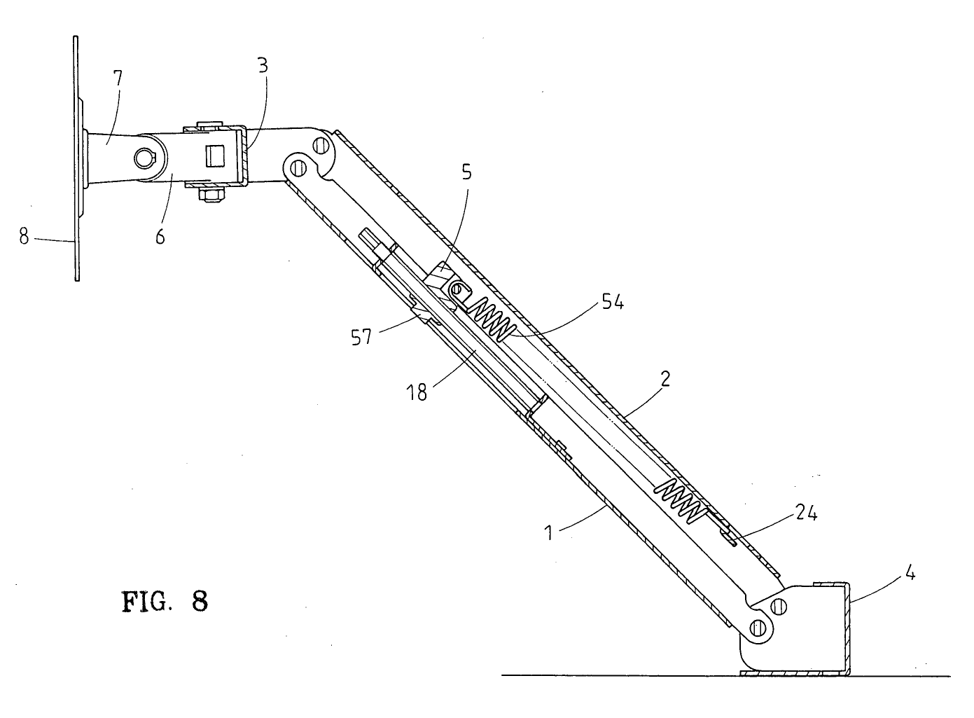

Referring to FIG. 8, the screw rod 18 can be turned to alter the tension of the elastic elements 54 before moving the liquid crystal display to the desired position. The main frame and the connecting seat 3 are pivoted to the desired position after adjusting the screw rod 18. A large tension is provided for supporting the liquid crystal display in this inclined state.

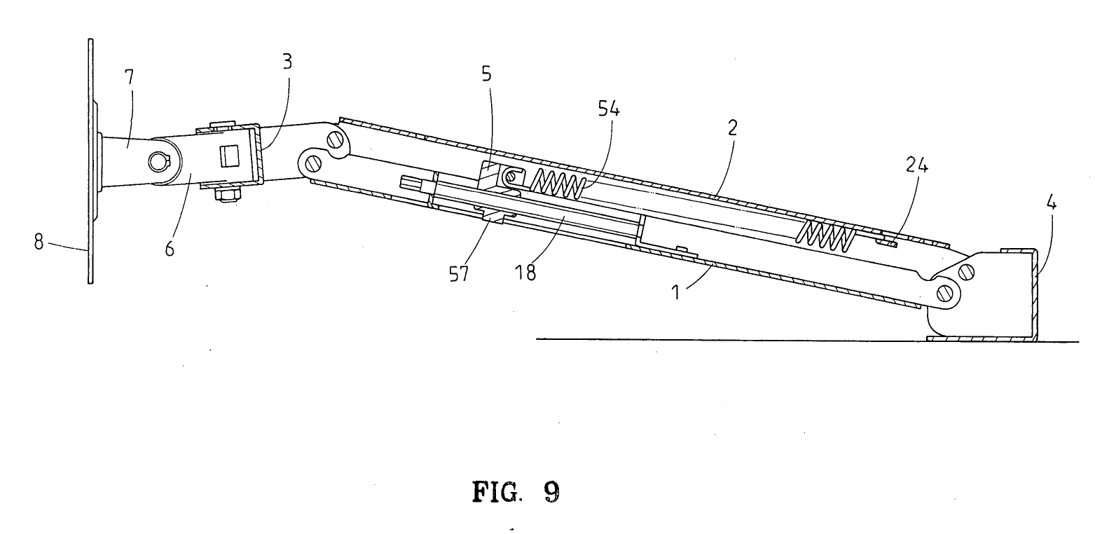

In a case that the liquid crystal display is moved to a further inclined state shown in FIG. 9, the elastic elements 54 are further stretched in response to the change of the position of the main frame and the connecting seat 3. Of course, the user may turn the screw rod 18 further to provide a larger tension of the elastic elements 54 when moving the liquid crystal display to the further inclined state in FIG. 9.

Referring to FIGS. 1, 6, and 7, the tension adjusting device may further comprise means for indicating the tension of the elastic elements 54. In the illustrated embodiment, the first frame 1 comprises a slot, opening or window 17 extending along a longitudinal direction, and the adjusting block 5 comprises an indicator 57 that is visible through the window 17. Thus, the user may see the position of the indicator 57 and thus be aware of the tension of the elastic elements 54. In this embodiment, the indicator 57 is movably received in the window 17 of the first frame 1.

Further, the support assembly with the tension adjusting device in accordance with the present invention can be used with liquid crystal displays of various types and weights. The tension adjusting device can be adjusted to alter the tension for supporting liquid crystal displays of different weights.

Although specific embodiments have been illustrated and described, numerous modifications and variations are still possible without departing from the essence of the invention. The scope of the invention is limited by the accompanying claims.

What is claimed is:

1. A support assembly for a liquid crystal display comprising:
a main frame comprising a first end and a second end adapted to be pivotally mounted to an object;
a connecting seat mounted to the first end of the main frame;
a coupler mounted to the connecting seat;
a liquid crystal display mounting member mounted to the connecting seat; and
a tension adjusting device comprising an adjusting block, at least one elastic element including a first end attached to the adjusting block to move therewith and a second end fixed to the main frame, and means for moving the adjusting block for altering tension of said at least one elastic element for supporting a liquid crystal display adapted to be mounted to the liquid crystal display mounting member.

2. The support assembly for a liquid crystal display as claimed in claim 1 wherein the connecting seat is pivotally connected to the first end of the main frame.

3. The support assembly for a liquid crystal display as claimed in claim 1 wherein the coupler is pivotally connected to the connecting seat.

4. The support assembly for a liquid crystal display as claimed in claim 1 wherein the liquid crystal display mounting member is pivotally connected to the connecting seat.

5. The support assembly for a liquid crystal display as claimed in claim 1 wherein the main frame comprises a first bracket having a hole and a second bracket having a hole aligned with the hole of the first bracket, the adjusting block comprising a screw hole, said means for moving the adjusting block comprising a screw rod extending through the holes of the first bracket and the second bracket and the screw hole of the adjusting block, the screw rod being turnable to cause the adjusting block to move relative to the main frame.

6. The support assembly for a liquid crystal display as claimed in claim 1 further comprising at least one guide rod fixed to the main frame, said at least one elastic element being mounted around said at least one guide rod.

7. The support assembly for a liquid crystal display as claimed in claim 5 further comprising at least one guide rod fixed between the first bracket and the second bracket and extending through the adjusting block.

8. The support assembly for a liquid crystal display as claimed in claim 1 further comprising means for indicating the tension of said at least one elastic element.

9. The support assembly for a liquid crystal display as claimed in claim 8 wherein the adjusting block comprises an indicator visible from outside of the main frame.

10. The support assembly for a liquid crystal display as claimed in claim 9 wherein the main frame comprises a window through which the indicator of the adjusting block is visible.

11. The support assembly for a liquid crystal display as claimed in claim 5 wherein the main frame comprises a first frame and a second frame, the first bracket and the second bracket being fixed to the first frame, the second end of said at least one elastic element being attached to the second frame.

12. The support assembly for a liquid crystal display as claimed in claim 11 further comprising at least one guide rod fixed between the first bracket and the second bracket and extending through the adjusting block.

13. The support assembly for a liquid crystal display as claimed in claim 12 further comprising means for indicating the tension of said at least one elastic element.

14. The support assembly for a liquid crystal display as claimed in claim 13 wherein the adjusting block comprises an indicator visible from outside of the main frame.

15. The support assembly for a liquid crystal display as claimed in claim 14 wherein the first frame comprises a window through which the indicator of the adjusting block is visible.

16. The support assembly for a liquid crystal display as claimed in claim 1 wherein the adjusting block comprises a bar having at least one groove into which the first end of said at least one elastic element is mounted.

17. The support assembly for a liquid crystal display as claimed in claim 6 wherein the adjusting block comprises a bar having at least one groove into which the first end of said at least one elastic element is mounted.

18. The support assembly for a liquid crystal display as claimed in claim 10 wherein the adjusting block comprises a bar having at least one groove into which the first end of said at least one elastic element is mounted.
